(19) United States
(12) Patent Application Publication
(10) Pub. No.: US 2019/0043645 A1
(43) Pub. Date: Feb. 7, 2019

(54) WIRE BONDING METHOD

(71) Applicant: Yazaki Corporation, Tokyo (JP)

(72) Inventor: Yasunori NABETA, Shizuoka (JP)

(73) Assignee: Yazaki Corporation, Tokyo (JP)

(21) Appl. No.: 16/045,837

(22) Filed: Jul. 26, 2018

(30) Foreign Application Priority Data
Aug. 2, 2017 (JP) 2017-149823

(51) Int. Cl. H01B 13/00; B23K 20/00; B23K 20/10; B23K 37/04

(52) U.S. Cl. CPC H01B 13/0023; H01B 13/0036; B23K 2101/32; B23K 20/10; B23K 37/0426; B23K 20/004

(57) ABSTRACT

A wire bonding method includes: arranging a plurality of wires by inserting the wires with partially-exposed conductors into each groove of a wire arrangement tool provided with a plurality of grooves; and sandwiching the conductors of the plurality of wires arranged by the wire arrangement tool in a predetermined direction and bonding the conductors to each other. Further, in this wire bonding method, the sandwiching causes one arbitrary conductor among the conductors to receive a biasing force in a direction intersecting a direction of a force applied by the sandwiching, from another conductor in contact with the one arbitrary conductor among the conductors.

### CROSS REFERENCE TO RELATED APPLICATION

This application is based upon and claims the benefit of priority from the prior Japanese Patent Application No. 2017-149823 (filing date: Aug. 2, 2017), the entire contents of which are incorporated herein by reference.

### BACKGROUND

### Technical Field

The present invention relates to a wire bonding method, and particularly to a method of bonding conductors of a plurality of wires to each other.

### Related Art

Conventionally, a wire bonding method of bonding conductors of a plurality of wires, which have the conductors exposed at one end in a longitudinal direction due to removal of a sheath, to each other by ultrasonic bonding, for example.

In this bonding method, as illustrated in FIGS. 9A and 9B, a plurality of conductors 3a, 3b, and 3c are arranged side by side between a pair of dies aligned in a lateral direction, the conductors 3a, 3b, and 3c are sandwiched between a hone and an anvil, aligned in the vertical direction, at a predetermined pressure P, and the hone is ultrasonically vibrated in a direction orthogonal to a paper surface of FIG. 9A, thereby ultrasonically bonding the conductors 3a, 3b, and 3c to each other.

Incidentally, JP 2007-509758 A can be listed as a technical literature relating to the related art.

### SUMMARY

Meanwhile, the conductors 3a, 3b, and 3c are sandwiched between the hone and the anvil in the up-down direction of FIG. 9A in the conventional wire bonding method. In FIG. 9A, however, the pressure in the lateral direction is not applied between the conductors that are adjacent in the lateral direction, that is, between the conductor 3a and the conductor 3b and between the conductor 3b and the conductor 3c. Thus, there is a problem that there is a risk of occurrence of bonding failure among the conductors 3a, 3b, and 3c in the configuration of FIG. 9A.

This problem also arises in the case of bonding conductors to each other by a method other than the ultrasonic bonding.

An object of the invention is to provide a wire bonding method capable of suppressing the occurrence of bonding failure between conductors in a wire bonding method and a wire arrangement tool for bonding exposed conductors of a plurality of wires.

A wire bonding method according to a first aspect of the invention includes: arranging a plurality of wires by inserting the wires with partially-exposed conductors into each groove of a wire arrangement tool provided with a plurality of grooves; and sandwiching the conductors of the plurality of wires arranged by the wire arrangement tool in a predetermined direction and bonding the conductors to each other. Further, in this wire bonding method, the sandwiching causes one arbitrary conductor among the conductors to receive a biasing force in a direction intersecting a direction of a force applied by the sandwiching, from another conductor in contact with the one arbitrary conductor among the conductors.

A width of at least one groove among the plurality of grooves of the wire arrangement tool may be different from a width of the other grooves. Further, arranging of the plurality of wires may be a step for arranging the wires by inserting the wires having outer diameters matching the widths of the grooves, into the respective grooves of the wire arrangement tool.

When inserting the wire into the groove of the wire arrangement tool, a depth direction of the groove may be a direction in which the conductor is sandwiched in the bonding of the conductors. Further, the wire bonding method may further include: rotating the wire arrangement tool by a predetermined angle relatively to the sandwiching direction after arranging the plurality of wires and before the bonding of the conductors.

The wire arrangement tool may be provided with an anti-slip piece configured to prevent the wire inserted into the groove from slipping out of the groove.

A depth of at least one groove among the grooves of the wire arrangement tool may be different from a depth of the other grooves.

The plurality of wires may be inserted into the grooves of the wire arrangement tool after installing an attachment on a bottom of the groove of the wire arrangement tool.

The width of the groove of the wire arrangement tool may be configured to be freely adjustable.

The sandwiching of the conductor may be performed by moving at least one sandwiching member between a pair of sandwiching members opposing each other in a direction in which a distance between the pair of sandwiching members decreases. Further, the bonding of the conductors may be a step for bonding the conductors to each other by ultrasonic bonding. At this time, one of the sandwiching members may be an anvil and the other sandwiching member may be a hone. Further, in the bonding of the conductors, a thick conductor of the wire may be positioned on a side of the hone and a thin conductor of the wire may be positioned on a side of the anvil.

A wire bonding method according to a second aspect of the invention includes: arranging a plurality of wires; and sandwiching conductors of the plurality of wires arranged in a predetermined direction and bonding the conductors to each other. Further, in this wire bonding method, the sandwiching of the conductors causes one arbitrary conductor among the conductors to receive a biasing force in a direction intersecting a direction of a force applied by the sandwiching, from another conductor in contact with the one arbitrary conductor among the conductors.

The wire bonding method according to the aspects of the invention suppress the occurrence of bonding failure between the exposed conductors of the plurality of wires in the wire bonding method and in the wire arrangement tool.

### BRIEF DESCRIPTION OF DRAWINGS

FIG. 1A is a front view illustrating a schematic configuration of a wire arrangement tool according to an embodiment of the invention;

FIG. 1B is a view taken along an arrow IB in FIG. 1A;

FIG. 1C is a perspective view illustrating the schematic configuration of the wire arrangement tool according to the embodiment of the invention;

FIG. 2A is a front view illustrating a state where wires are installed in the wire arrangement tool according to the embodiment of the invention;

FIG. 2B is a view taken along an arrow IIB in FIG. 2A;

FIG. 2C is a perspective view illustrating the state where the wires are installed in the wire arrangement tool according to the embodiment of the invention;

FIG. 3A is a front view illustrating a state where the wire arrangement tool in which the wires are installed is rotated together with the wires and inclined in a wire bonding method according to an embodiment of the invention;

FIG. 3B is a perspective view illustrating the state where the wire arrangement tool in which the wires are installed is rotated together with the wires and inclined in the wire bonding method according to the embodiment of the invention;

FIG. 4 is a front view illustrating a state when inclining the wires and the wire arrangement tool and ultrasonically bonding conductors of the wires in the wire bonding method according to the embodiment of the invention;

FIG. 5A is a front view illustrating a wire arrangement tool according to a modified example;

FIG. 5B is an enlarged view of a part of FIG. 5A;

FIG. 5C is a view illustrating a state where wires are installed in the wire arrangement tool according to the modified example;

FIG. 6A is a front view illustrating a wire arrangement tool (wire arrangement tool n which wires are installed) according to a modified example;

FIG. 6B is a view illustrating a state where the wire arrangement tool illustrated in FIG. 6A is rotated and inclined;

FIG. 7A is a perspective view illustrating attachments to be installed in the wire arrangement tool illustrated in FIGS. 1A to 1C;

FIG. 7B is a front view of the wire arrangement tool in which the attachments and the wires are installed;

FIG. 8A is a view illustrating a wire arrangement tool according to a modified example in a state before a width of a groove in which wires are installed is adjusted;

FIG. 8B is a view illustrating the wire arrangement tool according to the modified example in a state where the wires are installed and the width of the groove is adjusted;

FIG. 9A is a front view illustrating an outline of ultrasonic bonding according to a comparative example;

FIG. 9B is a cross-sectional view taken along a line IXB-IXB in FIG. 9A;

FIG. 10A is a front view illustrating an outline of ultrasonic bonding using the wire arrangement tool according to the embodiment of the invention;

FIG. 10B is a cross-sectional view taken along a line XB-XB in FIG. 10A;

FIG. 11A is a front view illustrating a configuration obtained by changing the number of conductors from an aspect illustrated in FIGS. 10A and 10B; and

FIG. 11B is a front view illustrating a configuration obtained by changing the number of conductors from an aspect illustrated in FIGS. 9A and 9B.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for embodiments of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

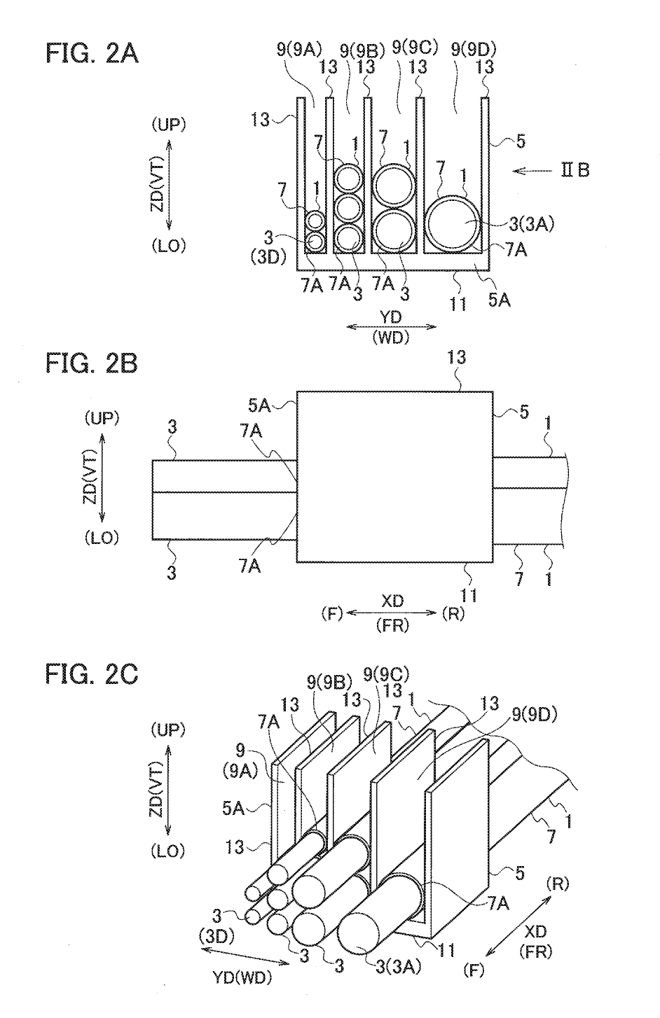

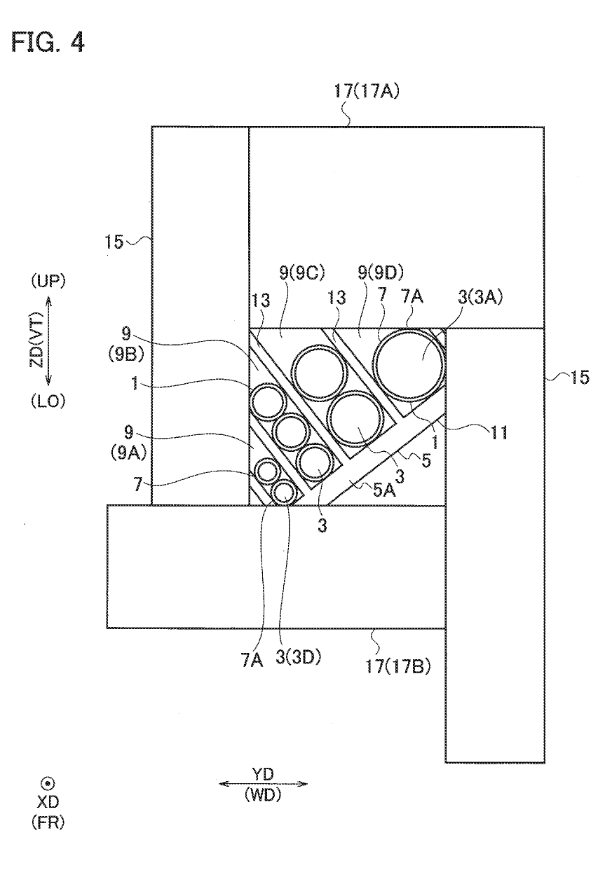

A wire bonding method according to an embodiment of the invention is configured to bond conductors 3 of a plurality of wires 1 to each other, and includes a wire arrangement process (see FIGS. 2A to 2C and the like) and a bonding process (see FIG. 4 and the like). Details of the wire arrangement process and the bonding process will be described later.

Here, for convenience of description, it is assumed that one predetermined horizontal direction in the space is an X direction XD, one predetermined horizontal direction orthogonal to the X direction XD is a Y direction YD, and a direction (up-down direction) orthogonal to the X direction XD and the Y direction YD is a Z direction ZD.

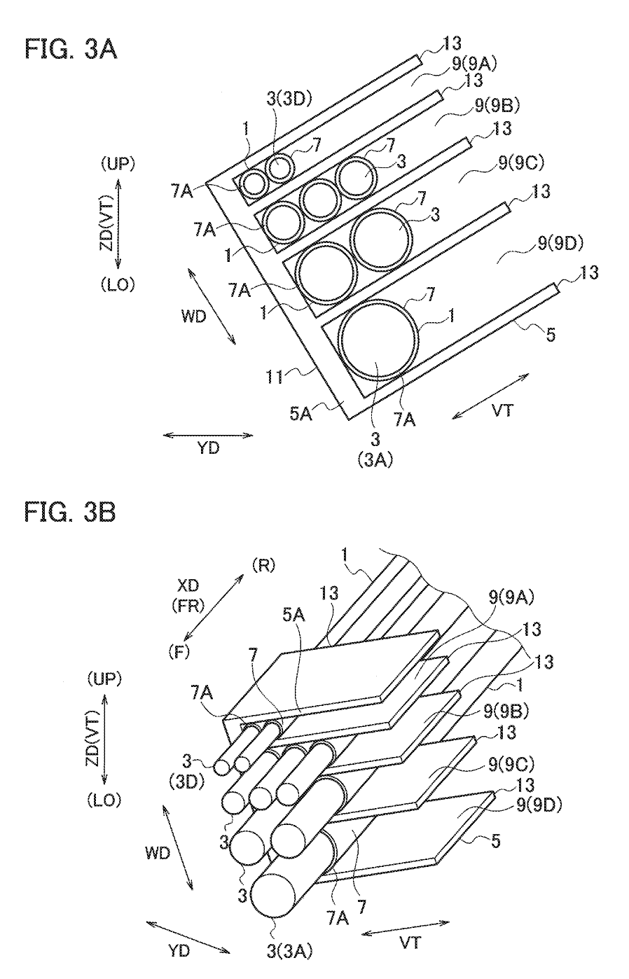

In addition, it is assumed that a longitudinal direction of the wire 1 is a front-rear direction FR, one predetermined direction orthogonal to the front-rear direction FR is a width direction WD (lateral direction), and a direction orthogonal to the front-rear direction. FR and the width direction WD is a vertical direction VT (height direction). Incidentally, the width direction WD and the vertical direction VT become directions inclined obliquely with respect to the horizontal direction by rotating a wire arrangement tool (wire alignment tool) 5 (see FIG. 3A and the like) although details thereof will be described later.

The wire 1 is constituted by a conductor (core wire) 3 and a sheath (insulator) 7 with which the conductor 3 is covered (coated) as illustrated in FIG. 2C and the like. The sheath 7 is removed over a predetermined length at a part (for example, one end) of the wire 1 in the longitudinal direction to expose the conductor 3 (a sheath removal process).

The wire 1 has flexibility. In addition, a cross section of the wire 1 taken along a plane orthogonal to the longitudinal direction is formed in a predetermined shape such as a circular shape as illustrated in FIG. 2A and the like.

More specifically, the conductor 3 is constituted by, for example, a plurality of strands (not illustrated). The strand is formed in an elongated cylindrical shape with metal such as copper, aluminum, and an aluminum alloy.

The conductor 3 is configured in a form in which the plurality of strands are twisted or a form in which the plurality of strands collectively extend in a straight line. A cross section of the conductor 3 is formed in a substantially circular shape as the plurality of strands is bundled with almost no gap.

A cross section of the sheath 7 is formed in an annular shape having a predetermined width (thickness). The entire inner circumference of the sheath 7 is in contact with the entire outer circumference of the conductor 3. Incidentally, there is also a case where the conductor 3 is constituted by a single strand.

In the sheath removal process, the sheath 7 is removed for each of the plurality of wires 1 having mutually different thicknesses and different diameters of the conductor 3 and the sheaths 7. Incidentally, lengths of the sheaths 7 to be removed are equal to each other regardless of the thicknesses of the wires 1 (see FIG. 2C and the like).

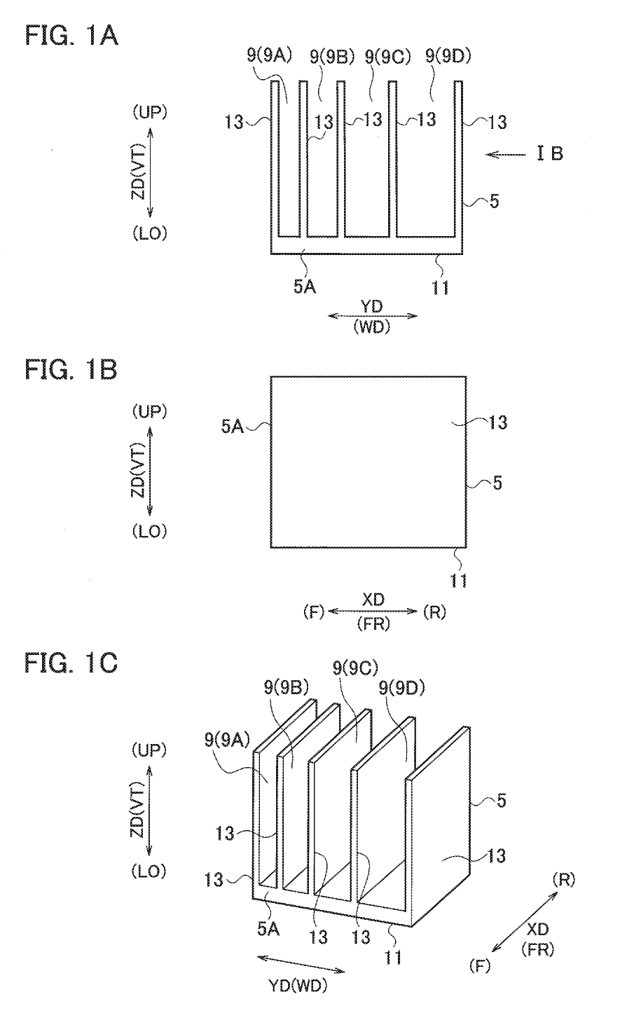

A plurality of grooves (wire arrangement grooves) q are provided in the wire arrangement tool 5 at predetermined slight intervals in the width direction WD of these grooves 9 (see FIG. 1A and the like).

In the wire arrangement process, the plurality of wires 1 are arranged (aligned) by inserting (inserting and installing) the wire 1, which has the conductor 3 partially exposed due to the removal of the sheath 7 in the sheath removal process, into each of the grooves 9 of the wire arrangement tool 5 (see FIGS. 2A, 2C, and the like).

The groove 9 of the wire arrangement tool 5 is formed in a rectangular shape with an open upper end in a state where the width direction WD coincides with the Y direction YD and the vertical direction VD coincides with the Z direction ZD when viewed from the front-rear direction FR as illustrated in FIG. 1A and the like. Each of the plurality of grooves 9 has a depth direction along the up-down direction (Z direction ZD).

More specifically, the wire arrangement tool 5 is configured to include a flat plate-shaped bottom plate 11 and a plurality of flat plate-shaped side plates 13. The side plates 13 form thin partition walls that separate the grooves 9 adjoining to each other.

A thickness direction of the bottom plate 11 coincides with the vertical direction VT, a thickness direction of each of the side plates 13 coincides with the width direction WD, and each of the side plates 13 is erected, for example, upward from the bottom plate 11 with a gap therebetween in the width direction WD to be provided integrally with the bottom plate 11.

A position of a front end of the bottom plate 11 and a position of a front end of each of the side plates 13 coincide with each other in the front-rear direction FR, and positions of upper ends of the side plates 13 coincide with each other in the up-down direction.

In addition, a distance between the side plates 13 adjacent to each other in each side plate in the width direction WD is a width of the groove 9. A value of the thickness of the side plate 13 is set to be smaller than a value of the width of the groove 9 and a value of a diameter of the conductor 3 of the wire 1 installed in the groove 9.

In the bonding process, the conductors 3 of the wires 1 arranged in the wire arrangement process are sandwiched in a predetermined direction (for example, the vertical direction VT), and the conductors 3 are bonded (ultrasonically bonded, for example) to each other.

When the sandwiching is performed in the bonding process, the conductors 3 are arranged in the form of piled bales as viewed in the longitudinal direction (front-rear direction FR; X direction XD) of the wire 1 as illustrated in FIGS. 4, 10A, and 11A, and the like. The sandwiching in the bonding process causes one arbitrary conductor among the conductors 3 (any conductor among the conductors 3) to receive a biasing force in a direction intersecting a direction (for example, the up-down direction) of a force applied by the sandwiching, from another conductor in contact with the one arbitrary conductor among the conductors 3.

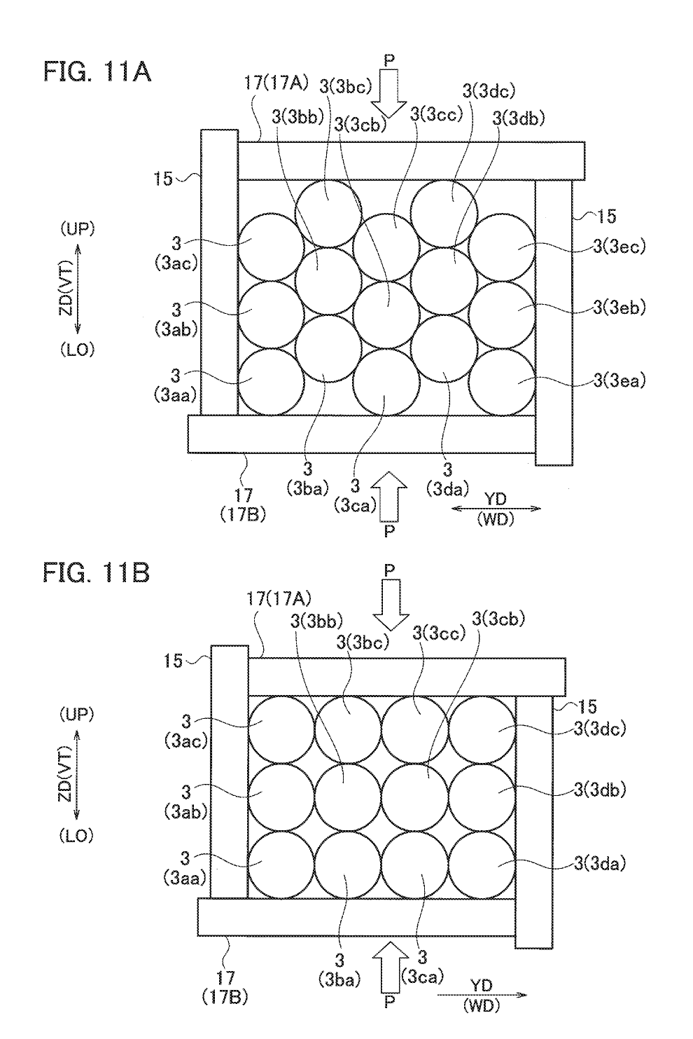

In other words, all of the conductors 3 are connected with the biasing forces by performing the sandwiching in the bonding process. That is, the second conductor is in contact with the first conductor 3 with the biasing force, and the third conductor is in contact with the second conductor 3 with the biasing force. In this manner, all of the conductors 3 are continuously in contact with each other with the biasing forces. Meanwhile, there are both a case where such contact with the biasing force is made in one way (to be described in detail later using FIG. 10A) and a case where the contact is made with a detour (to be described in detail later using FIG. 11A).

When sandwiching the conductor 3 in the bonding process, first, the plurality of conductors 3 are installed in a rectangular space as viewed in the front-rear direction FR between a pair of members 15 opposing each other with a predetermined distance therebetween in the Y direction YD and between a pair of sandwiching members 17 opposing each other with a predetermined distance therebetween in the Z direction ZD as illustrated in FIG. 4.

Surfaces of the pair of members 15 opposing each other are flat surfaces parallel to each other (flat surfaces orthogonal to the Y direction YD). In addition, surfaces of the pair of sandwiching members 17 opposing each other are flat surfaces parallel to each other (flat surfaces orthogonal to the Z direction ZD). In addition, the wire arrangement tool 5 and the members 15 and 17 are separated by a predetermined distance in the front-rear direction FR as a distal end of the exposed conductor 3 is sandwiched by the members 15 and 17.

Subsequently, the sandwiching of the conductor 3 in the bonding process is performed by moving at least one sandwiching member (for example, the sandwiching member 17A) between the pair of sandwiching members 17 (17A and 17B), which oppose each other in the Z direction ZD, in a direction (Z direction ZD; downward direction) in which the distance between the pair of sandwiching members 17 decreases. At this time, the distance between the pair of members 15 may be suitably decreased.

When the conductors 3 are sandwiched in the bonding process, the conductors 3 exposed in a cantilever shape are elastically deformed (bent between the wire arrangement tool 5 and the member 15 or the sandwiching member 17) so that the conductors 3 are arranged in the form of piled bales and in contact with each other with the biasing forces as described above, as illustrated in FIGS. 10A and 11A.

In the bonding process, the conductors 3 are bonded to each other, for example, by ultrasonic bonding as described above. Therefore, the one sandwiching member 17A is an anvil and the other sandwiching member is a hone 17B. The hone 17B vibrates in a direction VD (X direction XD) orthogonal to the paper surface of FIGS. 4, 10A, and 11A.

Although a thick conductor 3A is positioned on a side of the anvil 17A in FIG. 4, it is desirable that the thick conductor 3A be positioned on a side of the hone 17B and a thin conductor 3D be positioned on the side of the anvil 17A. When the thick conductor 3A is positioned on the side of the anvil 17A and the thin conductor 3D is positioned on the side of the hone 17B, there is a case where strands of the thin wire are hardly pressed by the anvil 17A depending on an aspect of the arrangement of the wire 1. In addition, the side of the hone 17B is a place where a pressure force is applied the most, and there is a risk that strands are cut due to excessive compression and vibration of the hone 17B if the strands of the thin wire are positioned on the side of the hone 17B. Thus, it is desirable that the thick conductor 3A be positioned on the side of the hone 17B and the thin conductor 3D be positioned on the anvil 17A side.

As illustrated in FIG. 1A and the like, a width of at least one groove among the grooves 9 is different from the width of the other grooves in the wire arrangement tool 5.

As illustrated in FIG. 2A and the like, in the wire arrangement process, the wires 1 are arranged by inserting the wires 1 having outer diameters matching the widths of the grooves 9, into the respective grooves 9 of the wire arrangement tool 5.

The width of each of the grooves 9 of the wire arrangement tool 5 will be described. For example, the widths of the respective grooves 9 are different from each other as the width of at least one groove is different from the width of the other grooves.

In addition, a value of the width of each of the grooves 9 increases from one end toward the other end in the width direction WD of the wire arrangement tool 5. For example, it is configured such that “a value of a width of a groove 9A positioned at the leftmost side<a value of a width of a groove 9B which is the second from the left<a value of a width of a groove 9C which is the third from the left<a value of a width of a groove 9D positioned on the rightmost side”.

Incidentally, it may be configured such that there are two or more grooves 9 having the same width. For example, it may be configured such that “the value of the width of the groove 9A positioned at the leftmost side=the value of the width of the groove 9B which is the second from the left<the value of the width of the groove 9C which is the third from the left<the value of the width of the groove 9D positioned on the rightmost side” in the wire arrangement tool 5 illustrated in FIG. 1A.

Further, grooves having different width values may be randomly arranged in the width direction WD of the wire arrangement tool 5 although the value of the width of each of the grooves 9 increases from one end to the other end in the width direction WD of the wire arrangement tool 5 in the above description.

When arranging the plurality of wires 1 using the wire arrangement tool 5, the width direction WD becomes the Y direction YD and the vertical direction VT becomes the Z direction ZD, for example, as illustrated in FIGS. 2A to 2C. In addition, one or a plurality of the wires 1 are inserted into each of the grooves 9 from above the grooves 9 when arranging the plurality of wires 1 using the wire arrangement tool 5. At this time, the wire 1 having the outer diameter matching the width of the groove 9 is inserted into the groove 9 as described above. That is, the value of the width of the groove 9 and the outer diameter of the wire 1 to be inserted into this groove 9 are equal to each other.

Here, a description will be given regarding the relationship between the wire arrangement tool 5 and the wire 1 in a state (wire arrangement state) where the wires 1 have been inserted into the respective grooves 9 of the wire arrangement tool 5 and the arrangement (installation) has been completed with reference to FIG. 2A and the like.

In the wire arrangement state, a lower end of the first wire 1 inserted into the groove 9 is brought into contact with the bottom plate 11, and each of both ends in the width direction WD thereof is brought into contact with each of the pair of side plates 13 positioned at both ends in the width direction WD of the groove 9. A lower end of the second or subsequent wire 1 inserted into the groove 9 is brought into contact with the wire 1 which has been already inserted into the groove 9, and each of both ends in the width direction WD thereof is brought into contact with each of the side plates 13 positioned at both the ends in the width direction WD of the groove 9. As a result, the wire 1 having been inserted into the groove 9 is restricted from moving in the downward direction, the width direction WD, and the front-rear direction FR so as to be hardly movable in such directions.

Although the wires 1 having the values of the outer diameters equal to the values of the widths of the grooves 9 are inserted into all the grooves 9 of the wire arrangement tool 5 in FIG. 2A, the wires 1 inserted into the groove 9 may have values of outer diameters slightly smaller than the value of the width of the groove 9. Conversely, an aspect in which a diameter of the wire 1 before being inserted into the groove 9 is slightly larger than the width of the groove 9, and the wire 1 is slightly elastically deformed in a state where the wire 1 has been installed in the groove 9 so that the wire 1 biases the side plates 13 on both sides of the groove 9 may be provided.

Further, it is unnecessary for the wires 1 to be inserted into all of the grooves 9 extending in the width direction WD, and the wire is not necessarily inserted into the groove 9 positioned at an end in the width direction WD, or the wire is not necessarily inserted into the groove 9 adjacent to the groove 9 positioned at the end in the width direction WD.

For example, in the wire arrangement tool 5 illustrated in FIG. 1A, the wire 1 is not inserted into the groove 9A positioned at the leftmost side and the groove 9B which is the second from the left, and the wire 1 may be inserted into the other grooves 9C and 9D. However, an aspect in which the wire 1 is not inserted into only the groove 9 (the groove 9B or the groove 9C) positioned in the middle in the width direction WD is not preferable.

The relationship between the wire arrangement tool 5 and the wire 1 in the front-rear direction FR in the wire arrangement state will be described.

A position of a front end 7A of the sheath 7 of the wire 1 and a position of a front end 5A of the wire arrangement tool 5 coincide with each other, and the exposed conductor 3 protrudes forward from the front end 5A of the wire arrangement tool 5 by a predetermined length. The positions of the respective front ends (distal ends) of the conductors 3 of the wires 1 coincide with each other.

In the wire arrangement state, a portion of the wire 1 covered with the sheath 7 is positioned inside the groove 9 of the wire arrangement tool 5. Therefore, the outer diameter of the wire 1 described above becomes an outer diameter of the sheath 7. In addition, a portion of the wire 1 covered with the sheath 7 extends rearward from a rear end of the wire arrangement tool 5 in the wire arrangement state.

Meanwhile, in the wire arrangement state, the position of the front end 7A of the sheath 7 of the wire 1 may be positioned slightly forward of the position of the front end 5A of the wire arrangement tool 5, or the position of the front end 7A of the sheath 7 of the wire 1 may be positioned inside the groove 9 of the wire arrangement tool 5.

Further, only the conductor 3 exposed due to removal of the sheath 7 may be positioned inside the groove 9 of the wire arrangement tool 5 in the wire arrangement state. In this case, the position of a front end of the conductor 3 is positioned at the front side F of the position of the front end 5A of the wire arrangement tool 5, and the position of the front end 7A of the sheath 7 is positioned at the slightly rear side R of the position of the rear end of the wire arrangement tool 5. In addition, the outer diameter of the wire 1 becomes the outer diameter of the conductor 3.

Meanwhile, when the wire 1 is inserted into the groove 9 of the wire arrangement tool 5, the depth direction of the groove 9 whose upper side is opened becomes the up-down direction (Z direction ZD) in the wire arrangement process as already understood from FIGS. 2A and 4. That is, the depth direction of the groove 9 becomes a direction in which the conductor 3 is sandwiched in the bonding process.

In addition, the wire arrangement tool 5 in which the wire 1 has been installed is rotated by a predetermined angle relatively to the sandwiching direction (Z direction ZD) after arranging the wire 1 in the wire arrangement process and before the bonding in the bonding process (a rotation process). This rotation process is performed in order to arrange the respective conductors 3 in the form of piled bales.

More specifically, the width direction WD of the wire arrangement tool 5 is the Y direction YD, and the vertical direction VT of the wire arrangement tool 5 is the Z direction ZD in the wire arrangement process, as described above.

A rotation center axis of the wire arrangement tool 5 in the rotation process is an axis extending in the front-rear direction FR, and a rotation angle of the wire arrangement tool 5 and the wire 1 in the rotation process is an angle at which the depth direction of the groove 9 (the vertical direction VT of the wire arrangement tool 5) obliquely intersects a movement direction (Z direction ZD) of the sandwiching member 17.

In other words, the rotation angle of the wire arrangement tool 5 and the wire 1 in the rotation process is an angle that causes the respective conductors 3 to be arranged in the form of piled bales after arranging the wires 1 in the wire arrangement process and before the bonding in the bonding process.

For example, the wire arrangement tool 5 and the wire 1 are rotated clockwise by a predetermined angle within a range of 10° to 90° from the state illustrated in FIG. 1A in the rotation process. Preferably, the wire arrangement tool 5 and the wire 1 are rotated clockwise by a predetermined angle within a range of 30° to 70° from the state illustrated in FIG. 1A in the rotation process. More preferably, the wire arrangement tool 5 and the wire 1 are rotated clockwise by a predetermined angle within a range of 40° to 50° from the state illustrated in FIG. 1A in the rotation process.

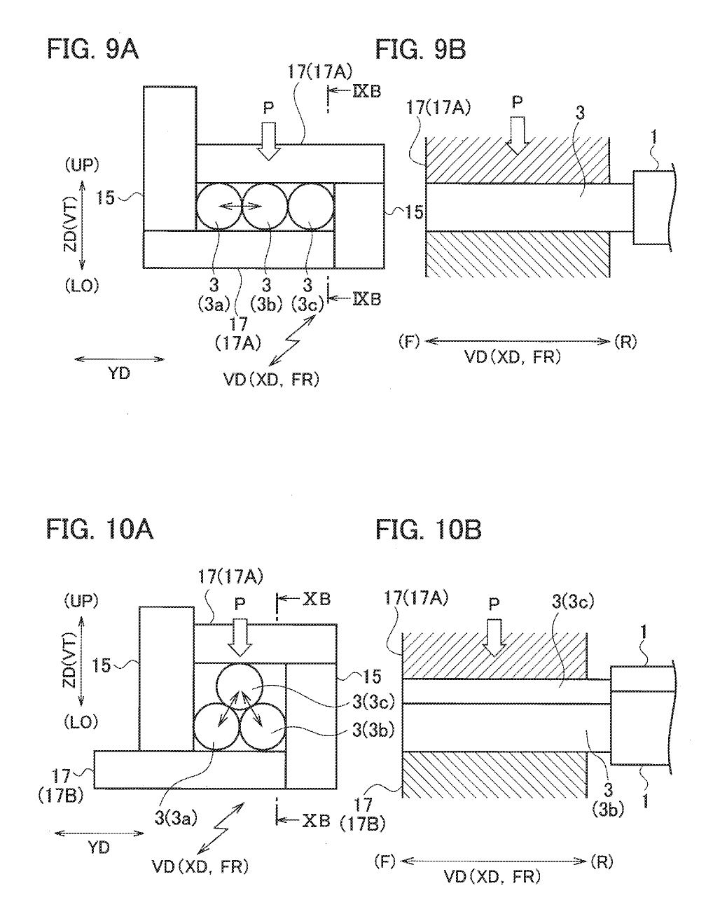

Here, a description will be given in detail regarding the point that the sandwiching in the bonding process causes one arbitrary conductor among the conductors 3 to receive the biasing force in a direction (oblique direction) intersecting the direction of the force applied by the sandwiching, from another conductor in contact with the one arbitrary conductor with reference to FIGS. 9A, 10A, and 11A.

In FIGS. 9A, 10A, and 11A, the conductors 3 have the same diameter in order to facilitate understanding.

In a comparative example illustrated in FIG. 9A, when three conductors 3 are sandwiched between members 15 and 17, pressure P is applied only in the up-down direction, and thus, no biasing force acts between a conductor 3a and a conductor 3b, and no biasing force acts between the conductor 3b and a conductor 3c either. Therefore, no biasing force acts among all the conductors 3.

Similarly, in a comparative example illustrated in FIG. 11B, no biasing force acts between a conductor 3aa and a conductor 3ba, between the conductor aha and a conductor 3ca, and between the conductor 3ca and a conductor 3da, and no biasing force acts between a conductor 3ab and a conductor 3bb, between the conductor 3bb and a conductor 3cb, and between the conductor 3cb and a conductor 3db either.

In addition, a biasing force acts between the conductor 3aa and the conductor 3ab, and a biasing force acts between the conductor 3ab and the conductor 3ac. However, a direction of the biasing force received by the conductor 3ab from the conductor 3aa and a direction of the biasing force received by the conductor 3ab from the conductor 3ac coincide with the direction (Z direction ZD) of the force generated by the sandwiching member 17.

Therefore, in the comparative examples illustrated in FIGS. 9A and 11B, it is difficult to say that an arbitrary conductor among the conductors 3 receives the biasing force in the direction (oblique direction) intersecting the direction of the force applied by the sandwiching, from another conductor in contact with the arbitrary conductor.

In addition, it is difficult to say that all of the conductors 3 are connected with the biasing forces in the comparative examples illustrated in FIGS. 9A and 11B.

On the other hand, in an aspect illustrated in FIG. 10A in which the conductors 3 are arranged in the form of piled bales, a biasing force acts between a conductor 3a and a conductor 3c, and a biasing force also acts between a conductor 3b and the conductor 3c. Therefore, it can be said that an arbitrary conductor among the conductors 3 receives the biasing force in the direction (oblique direction) intersecting the direction of the force applied by the sandwiching, from another conductor in contact with the arbitrary conductor.

In addition, it can be said that all of the conductors 3 (3a, 3b, and 3c) are connected with the biasing forces in the aspect illustrated in FIG. 10A, and that the contact with the biasing forces among the conductor 3a, the conductor 3b, and the conductor 3c is made in one way since no biasing force is generated between the conductor 3a and the conductor 3b.

In an aspect illustrated in FIG. 1.1A in which the conductors 3 are arranged in the form of piled bales, for example, a biasing force acts between a conductor 3aa and a conductor 3ba, and a biasing force also acts between a conductor 3ca and a conductor 3da. Thus, it can be said that an arbitrary conductor among the conductors 3 receives the biasing force in the direction (oblique direction) intersecting the direction of the force applied by the sandwiching, from another conductor in contact with the arbitrary conductor.

In addition, it can be said that all of the conductors 3 (3aa to 3ec) are connected with the biasing forces in the aspect illustrated in FIG. 11A, and that the contact with the biasing forces among the conductors 3aa to 3ec is made with a detour since the conductor 3bb is connected to the conductor 3ba with the biasing force between the conductor 3ab and the conductor 3cb.

According to the wire bonding method, since the wires 1 are arranged using the wire arrangement tool 5, the conductors 3 of the wires 1 can be collected in a stable state at the time of bonding the conductors 3 to each other.

In addition, according to the wire bonding method, as the sandwiching in the bonding process is performed, the respective conductors 3 are arranged in the form of piled bales, and the biasing force in the direction oblique to the direction of the force generated by the sandwiching of the sandwiching member 17 is generated between the conductors 3 which are in contact with each other. Thus, the bonding between the conductors 3 is accurately performed, and the occurrence of bonding failure between the conductors 3 can be suppressed.

In addition, according to the wire bonding method, the width of at least one groove among the grooves 9 of the wire arrangement tool 5 is different from the width of the other grooves; and the wires 1 are arranged by inserting the wires 1 having the outer diameters matching the widths of the grooves 9, into the respective grooves 9 of the wire arrangement tool 5 in the wire arrangement process. Thus, the wires 1 are arranged in the wire arrangement tool 5 so as not to rattle, and the conductors 3 of the wires 1 having different sizes can be accurately bonded to each other.

In addition, according to the wire bonding method, the wire arrangement tool 5 is rotated by the predetermined angle relatively to the sandwiching direction in the rotation process after arranging the wires 1 in the wire arrangement process and before the bonding in the bonding process. Thus, it is possible to arrange the conductors 3 of the wires 1 into the form of piled bales only with the simple process of rotating the wire arrangement tool 5 in which the wires 1 are arranged.

In addition, since the respective grooves 9 are provided with the predetermined slight intervals in the width direction WD according to the wire arrangement tool 5, the wires 1 (the conductors 3) approach each other when the wires 1 are installed in each of the grooves 9. As a result, it is possible to bond the conductors 3 to each other without increasing the length of the exposed conductor 3.

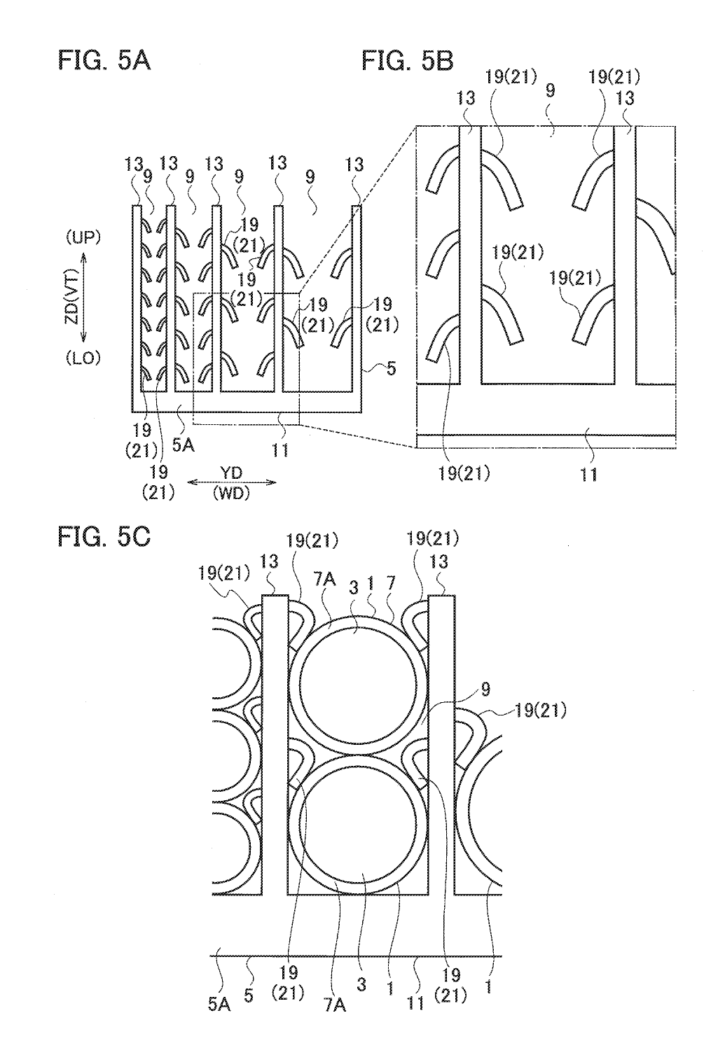

Next, a wire arrangement tool 5 according to a modified example will be described with reference to FIGS. 5A to 5C.

The wire arrangement tool 5 illustrated in FIGS. 5A to 5C is provided with an anti-slip piece 19 configured to prevent a wire 1 inserted into a groove 9 from slipping out of the groove 9.

A plurality of the anti-slip pieces 19 are provided at a predetermined interval in the vertical direction VT (the interval approximately the same as a value of an outer diameter of the wire 1) with respect to the single groove 9, for example. When a plurality of the wires 1 are inserted into the single groove 9, for example, each of the wires 1 is prevented from slipping by each of the anti-slip pieces 19.

More specifically, the anti-slip piece 19 is constituted by a pair of elastic pieces 21, which are elongated as viewed in the front-rear direction FR. One elastic piece 21 between the pair of elastic pieces 21 obliquely protrudes from one side plate 13 constituting the groove 9 toward the center of the groove 9 toward a bottom plate 11. In addition, the other elastic piece 21 between the pair of elastic pieces 21 is positioned at the same position as the one elastic piece 21 in the vertical direction VT, and protrudes obliquely from one side plate 13 constituting the groove 9 toward the center of the groove 9 toward the bottom plate 11.

When the wire 1 is installed in the groove 9, the pair of elastic pieces 21 are elastically deformed, and the elastic pieces 21 restore to a certain extent to be, for example, a “U” shape when the wire 1 passes over the pair of elastic pieces 21 so that the wire 1 abuts on the elastic pieces 21 so as to prevent the wire 1 from slipping out of the groove 9.

Incidentally, the wire 1 installed in the groove 9 of the wire arrangement tool 5 is biased in the depth direction of the groove 9 by the anti-slip piece 19. As a result, it is possible to more reliably prevent the rattling of the wire 1 that has been once installed in the groove 9.

In addition, it is possible to prevent the wire 1 from slipping out of the groove 9 particularly during the rotation process by providing the anti-slip piece 19.

Incidentally, the elastic piece 21 may be made of the same material as the side plate 13 or the bottom plate 11, or may be made of a different material. The elastic piece 21 may be configured separately from the side plate 13 or may be integrally molded with the side plate 13 and the bottom plate 11.

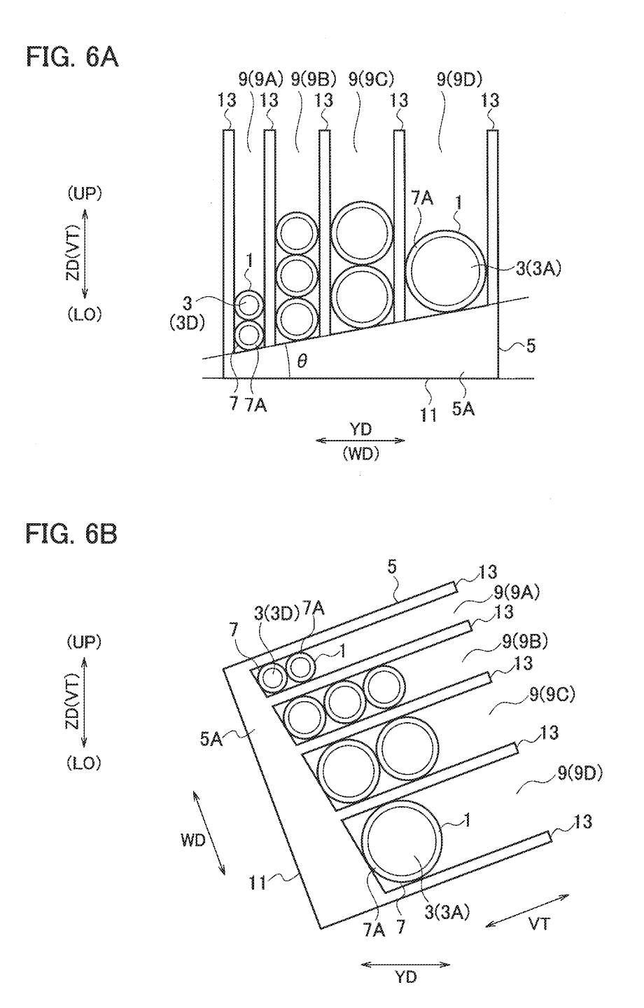

Next, a wire arrangement tool 5 according to another modified example will be described with reference to FIGS. 6A and 6B.

In the wire arrangement tool 5 illustrated in FIGS. 6A and 6B, a depth of at least one groove among grooves 9 is different from a depth of the other grooves, for example, in order to arrange a plurality of wires 1 installed in the wire arrangement tool 5 in the form of piled bales.

For example, the depths of the grooves 9 are different from each other since the depth of at least one groove among the grooves 9 of the wire arrangement tool 5 is different from the depth of other grooves. In this case, positions of bottom surfaces of the grooves 9 are different from each other in the up-down direction if positions of upper ends of the grooves 9 in the up-down direction coincide with each other.

This will be described in detail. The upper surface of the bottom plate 11 is inclined by a predetermined angle θ with respect to the horizontal plane as viewed in the front-rear direction FR. As a result, a value of the depth of each of the grooves 9 increases from one end toward the other end in the width direction WD of the wire arrangement tool 5.

Although there are no two or more grooves having the same depth in the above description, it may be configured such that there are two or more grooves having the same depth.

In addition, although the value of the depth of each of the grooves 9 decreases from one end to the other end in the width direction WD of the wire arrangement tool 5 in the above description, the value may increase conversely, or the grooves 9 having different depth values may be randomly arranged in the width direction WD of the wire arrangement tool 5.

Further, although the bottom surface of the groove 9 is inclined obliquely with respect to the horizontal plane in the above description, the bottom surface of the groove 9 may be horizontal.

In addition, the above-described rotation process may be omitted as long as it is possible to make the conductors 3 arranged in the form of piled bales by changing the depth of the groove 9 of the wire arrangement tool 5.

Since the depth of at least one groove among the grooves 9 is different from the depth of the other grooves according to the wire arrangement tool 5 illustrated in FIGS. 6A and 6B, the rotation process is unnecessary depending on the arrangement state of the wires 1 so that it is possible to simplify the process when the installation of the wire 1 in the groove 9 of the wire arrangement tool 5 is completed in the state where the vertical direction VT of the wire arrangement tool 5 becomes the Z direction ZD.

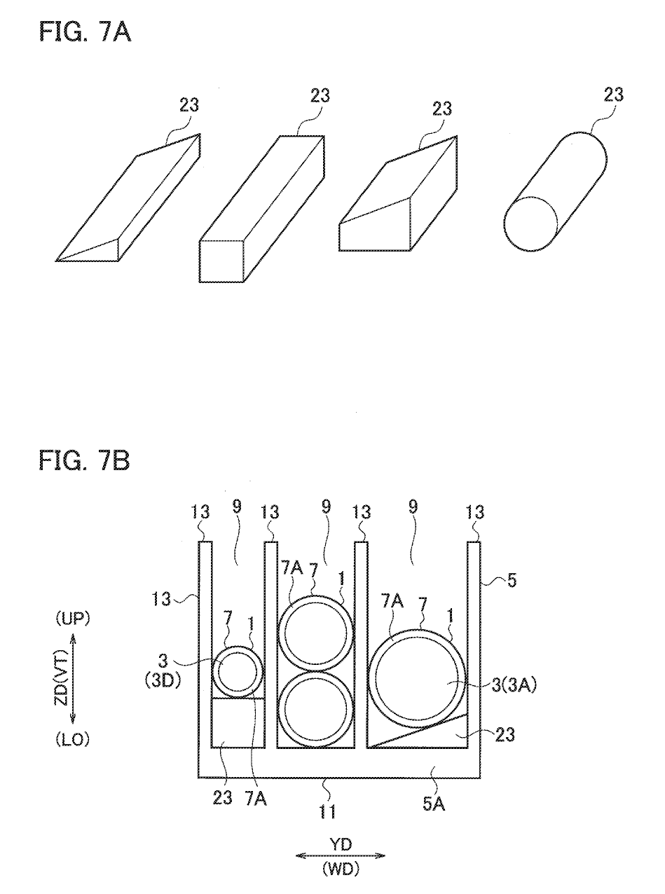

In addition, as illustrated in FIG. 7B, the wire 1 may be inserted into the groove 9 after installing an attachment (spacer) 23 illustrated in FIG. 7A at the bottom of the groove 9 of the wire arrangement tool 5 in the wire arrangement process.

The attachment 23 is installed in order to make the depth of the groove 9 and the bottom surface of the groove 9 inclined. With the attachment 23, it is possible to obtain substantially the same operational effect as the case of changing the depth of the groove 9 or the like as illustrated in FIGS. 6A and 6B.

As illustrated in FIG. 7A, a shape of the attachment 23 may be a triangular prism shape (a triangular prism shape whose bottom surface is, for example, a right triangle), may be a quadrangular prism shape, may be a trapezoidal prism shape (a trapezoidal prism shape whose bottom surface is a trapezoid with one oblique side perpendicular to a lower base or an upper base), or may be a cylindrical shape.

The attachment 23 installed inside the groove 9 is movable by applying a certain amount of force in the vertical direction VT (a direction away from the bottom plate 11) and the front-rear direction FR, but is not movable in the other directions by being blocked by the bottom plate 11 and the side plate 13.

As the attachment 23 is used in this manner, the rotation process is unnecessary in some cases and the process can be simplified similarly to the case of changing the depth of the groove of the wire arrangement tool 5. Further, the attachment 23 is freely detachable from the wire arrangement tool 5, and thus, it is easier to omit the rotation process if the form of the attachment 23 is changed in accordance with a size of the diameter of the wire 1 and the number of the wires 1.

Incidentally, the attachment 23 may be installed in the wire arrangement tool 5 illustrated in FIGS. 6A and 6B.

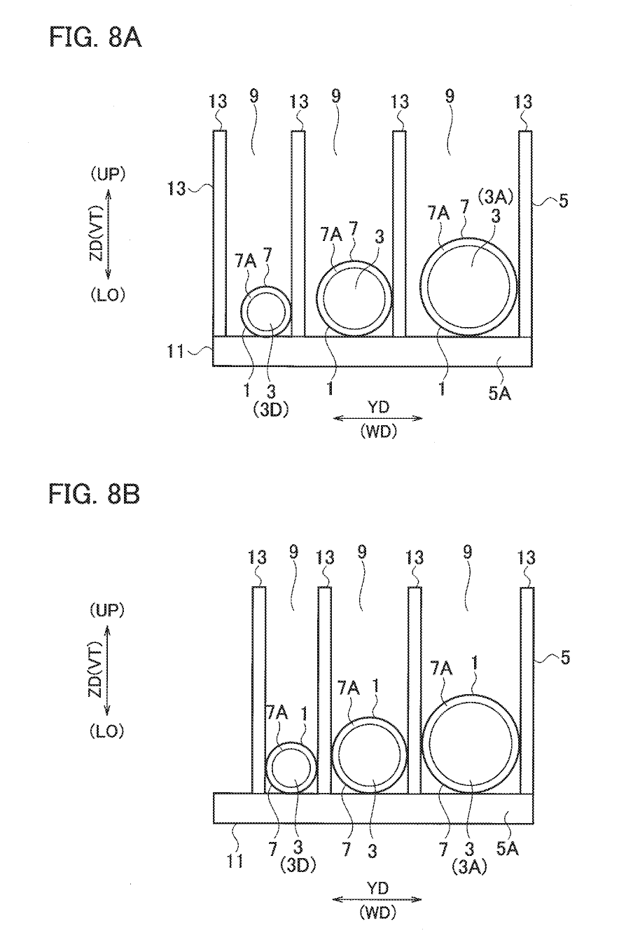

In addition, it may be configured such that the width of the groove 9 is freely adjustable (changeable) in the wire arrangement tool 5 as illustrated in FIGS. 8A and 8B. That is, the side plate 13 may be freely movable to be positioned in the width direction of the wire arrangement tool 5 with respect to the bottom plate 11.

As a result, it is possible to install the wires 1 having various diameters in the wire arrangement tool 5 without rattling. For example, if the value of the outer diameter of the wire 1 is smaller than the value of the width of the groove 9 as illustrated in FIG. 8A, the wire 1 installed in the wire arrangement tool 5 rattles, but it is possible to install the wire 1 inside the groove 9 in the state without rattling as illustrated in FIG. 8B by making the value of the width of the groove 9 equal to the value of the outer diameter of the wire 1.

Incidentally, the elastic piece 21 illustrated in FIGS. 6A and 6B may be provided so as to be movable to be positioned with respect to the side plate 13 in the vertical direction VT.

The above-described wire bonding method is an example of wire bonding methods including a wire arrangement process of arranging a plurality of wires and a bonding process of sandwiching conductors of the wires arranged in the wire arrangement process in a predetermined direction (for example, an up-down direction) and bonding the conductors to each other, in which the conductors are arranged in a form of piled bales as viewed in a longitudinal direction (front-rear direction FR) of the wire.

In addition, in a wire bonded body (not illustrated) manufactured by the above-described wire bonding method, the conductors of the plurality of wires in which a diameter of a conductor of at least one wire is different from a diameter of conductors of the other wires are bonded to each other, a thick conductor is positioned on one side, for example as viewed in the front-rear direction FR at a portion where the conductors are bonded to each other, and a thickness of the conductor gradually decreases from one side to the other side.

Embodiments of the present invention have been described above. However, the invention may be embodied in other specific forms without departing from the spirit or essential characteristics thereof. The present embodiments are therefore to the considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A wire bonding method comprising:
arranging a plurality of wires by inserting the wires with partially-exposed conductors into each groove of a wire arrangement tool provided with a plurality of grooves; and
sandwiching the conductors of the plurality of wires arranged by the wire arrangement tool in a predetermined direction and bonding the conductors to each other,
wherein the sandwiching causes one arbitrary conductor among the conductors to receive a biasing force in a direction intersecting a direction of a force applied by the sandwiching, from another conductor in contact with the one arbitrary conductor among the conductors.

2. The wire bonding method according to claim 1, wherein
a width of at least one groove among the plurality of grooves of the wire arrangement tool is different from a width of the other grooves, and
arranging of the plurality of wires is a step for arranging the wires by inserting the wires having outer diameters matching the widths of the grooves, into the respective grooves of the wire arrangement tool.

3. The wire bonding method according to claim 1, wherein
when inserting the wire into the groove of the wire arrangement tool, a depth direction of the groove is a direction in which the conductor is sandwiched in the bonding of the conductors,
wherein the wire bonding method further comprises
rotating the wire arrangement tool by a predetermined angle relatively to the sandwiching direction after arranging the plurality of wires and before the bonding of the conductors.

4. The wire bonding method according to claim 1, wherein
the wire arrangement tool is provided with an anti-slip piece configured to prevent the wire inserted into the groove from slipping out of the groove.

5. The wire bonding method according to claim 1, wherein
a depth of at least one groove among the grooves of the wire arrangement tool is different from a depth of the other grooves.

6. The wire bonding method according to claim 1, wherein
the plurality of wires is inserted into the grooves of the wire arrangement tool after installing an attachment on a bottom of the groove of the wire arrangement tool.

7. The wire bonding method according to claim 1, wherein
the width of the groove of the wire arrangement tool is configured to be freely adjustable.

8. The wire bonding method according to claim 1, wherein
the sandwiching of the conductor is performed by moving at least one sandwiching member between a pair of sandwiching members opposing each other in a direction in which a distance between the pair of sandwiching members decreases,
the bonding of the conductors is a step for bonding the conductors to each other by ultrasonic bonding,
one of the sandwiching members is an anvil and the other sandwiching member is a hone, and
in the bonding of the conductors, a thick conductor of the wire is positioned on a side of the hone and a thin conductor of the wire is positioned on a side of the anvil.

9. A wire bonding method comprising:
arranging a plurality of wires; and
sandwiching conductors of the plurality of wires arranged in a predetermined direction and bonding the conductors to each other,
wherein the sandwiching of the conductors causes one arbitrary conductor among the conductors to receive a biasing force in a direction intersecting a direction of a force applied by the sandwiching, from another conductor in contact with the one arbitrary conductor among the conductors.
